(19) United States
(12) Patent Application Publication
(10) Pub. No.: US 2026/0050356 A1
(43) Pub. Date: Feb. 19, 2026

(54) SYSTEM AND METHOD FOR TRACKING A USER-MANIPULATED OBJECT WITHIN AN INTERACTIVE ENVIRONMENT

(71) Applicant: Universal City Studios LLC, Universal City, CA (US)

(72) Inventor: Sarah La Forge, Titusville, FL (US)

(21) Appl. No.: 19/298,893

(22) Filed: Aug. 13, 2025

Related U.S. Application Data
(60) Provisional application No. 63/683,083, filed on Aug. 14, 2024.

(51) Int. Cl. G06F 3/04815; G06F 3/14; G06F 17/11

(52) U.S. Cl. CPC G06F 3/04815; G06F 3/14; G06F 17/11

(57) ABSTRACT

A tracking system for a user-manipulated object within an interactive environment includes a controller configured to receive a sensor signal indicative of a latest quaternion of the user-manipulated object and to update a quaternion array with the latest quaternion. The controller is also configured to determine a reference axis and a reference angle of the latest quaternion and to determine a relative angle and a relative time for each quaternion within the quaternion array except for the latest quaternion. Furthermore, the controller is configured to determine an angular velocity and an angular acceleration about the reference axis by applying a filter to a set of kinematic equations. The controller is also configured to determine a future angle of the user-manipulated object based on the angular velocity and the angular acceleration about the reference axis and to determine a future quaternion from the future angle and the reference axis.

### CROSS-REFERENCE TO RELATED APPLICATION

This application claims priority from and the benefit of U.S. Provisional Application Ser. No. 63/683,083, entitled “SYSTEM AND METHOD FOR TRACKING A USER-MANIPULATED OBJECT WITHIN AN INTERACTIVE ENVIRONMENT”, filed Aug. 14, 2024, which is hereby incorporated by reference in its entirety.

### BACKGROUND

The present disclosure relates generally to a system and method for tracking a user-manipulated object within an interactive environment.

Certain interactive environments may include a tracking system configured to monitor a position and an orientation of a user-manipulated object (e.g., a pointer, a simulated armament, etc.). For example, the tracking system may include one or more sensors configured to output sensor signal(s) indicative of the position and the orientation of the user-manipulated object. The interactive environment may also include a display and a controller communicatively coupled to the display and to the sensor(s). As the user moves and/or rotates the user-manipulated object, the controller may adjust an image on the display based on the position and/or the orientation of the user-manipulated object. Unfortunately, latency within the sensor(s) and/or the controller may establish a lag between movement and/or rotation of the user-manipulated object and the adjustment to the image on the display, thereby reducing user satisfaction with the interactive environment.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the claimed subject matter. Indeed, the claimed subject matter may encompass a variety of forms that may be similar to or different from the embodiments set forth below.

In an embodiment, a tracking system for a user-manipulated object within an interactive environment includes a controller having a memory and a processor. The controller is configured to receive a sensor signal, from a sensor, indicative of a latest quaternion of the user-manipulated object and to update a quaternion array with the latest quaternion. The quaternion array includes multiple quaternions, the quaternions are arranged in chronological order within the quaternion array, and updating the quaternion array with the latest quaternion includes adding the latest quaternion to the quaternion array and removing an oldest quaternion from the quaternion array. The controller is also configured to determine a reference axis and a reference angle of the latest quaternion and to determine a relative angle and a relative time for each quaternion within the quaternion array except for the latest quaternion. The relative angle is about the reference axis, the relative angle is determined via an axis projection process, and the relative time is a difference between a time of the quaternion and a time of the latest quaternion. Furthermore, the controller is configured to determine an angular velocity and an angular acceleration about the reference axis by applying a filter to a set of kinematic equations. The relative angle and the relative time for each quaternion within the quaternion array, except for the latest quaternion, are inputs for each respective kinematic equation. In addition, the controller is configured to determine a future angle of the user-manipulated object based on the angular velocity and the angular acceleration about the reference axis, to determine a future quaternion from the future angle and the reference axis, and to output an output signal indicative of the future quaternion.

Furthermore, in an embodiment, a method for tracking a user-manipulated object within an interactive environment includes receiving, via a controller having a memory and a processor, a sensor signal, from a sensor, indicative of a latest quaternion of the user-manipulated object and updating, via the controller, a quaternion array with the latest quaternion. The quaternion array includes multiple quaternions, the quaternions are arranged in chronological order within the quaternion array, and updating the quaternion array with the latest quaternion includes adding the latest quaternion to the quaternion array and removing an oldest quaternion from the quaternion array. Furthermore, the method includes determining, via the controller, a reference axis and a reference angle of the latest quaternion and determining, via the controller, a relative angle and a relative time for each quaternion within the quaternion array except for the latest quaternion. The relative angle is about the reference axis, the relative angle is determined via an axis projection process, and the relative time is a difference between a time of the quaternion and a time of the latest quaternion. The method also includes determining, via the controller, an angular velocity and an angular acceleration about the reference axis by applying a filter to a set of kinematic equations. The relative angle and the relative time for each quaternion within the quaternion array, except for the latest quaternion, are inputs for each respective kinematic equation. In addition, the method includes determining, via the controller, a future angle of the user-manipulated object based on the angular velocity and the angular acceleration about the reference axis, determining, via the controller, a future quaternion from the future angle and the reference axis, and outputting, via the controller, an output signal indicative of the future quaternion.

In addition, in an embodiment, an interactive environment includes a user-manipulated object, a display, and a tracking system having a sensor configured to output a sensor signal indicative of a latest quaternion of the user-manipulated object and a controller including a memory and a processor. The controller is communicatively coupled to the sensor, and the controller is configured to receive the sensor signal, from the sensor, indicative of the latest quaternion of the user-manipulated object and to update a quaternion array with the latest quaternion. The quaternion array includes multiple quaternions, the quaternions are arranged in chronological order within the quaternion array, and updating the quaternion array with the latest quaternion includes adding the latest quaternion to the quaternion array and removing an oldest quaternion from the quaternion array. The controller is also configured to determine a reference axis and a reference angle of the latest quaternion and to determine a relative angle and a relative time for each quaternion within the quaternion array except for the latest quaternion. The relative angle is about the reference axis, the relative angle is determined via an axis projection process, and the relative time is a difference between a time of the quaternion and a time of the latest quaternion. Furthermore, the controller is configured to determine an angular velocity and an angular acceleration about the reference axis by applying a filter to a set of kinematic equations. The relative angle and the relative time for each quaternion within the quaternion array, except for the latest quaternion, are inputs for each respective kinematic equation of the set of kinematic equations. In addition, the controller is configured to determine a future angle of the user-manipulated object based on the angular velocity and the angular acceleration about the reference axis, to determine a future quaternion from the future angle and the reference axis, and to output an output signal indicative of instructions to adjust an image on the display based on the future quaternion.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an interactive environment;

FIG. 2 is a block diagram of an embodiment of a tracking system for a user-manipulated object that may be employed within the interactive environment of FIG. 1;

FIG. 3 is a flow diagram of an embodiment of a method for tracking a user-manipulated object within an interactive environment; and

FIG. 4 is a flow diagram of an embodiment of a relative angle determination process, including an axis projection process, which may be employed within the method of FIG. 3.

### DETAILED DESCRIPTION

One or more specific embodiments of the present disclosure will be described below. To provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

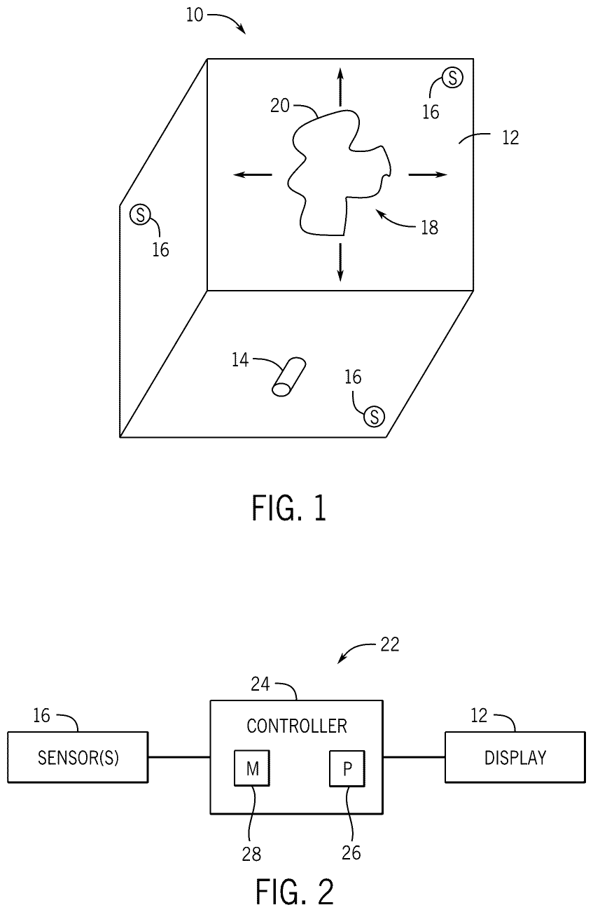

FIG. 1 is a perspective view of an embodiment of an interactive environment 10. In the illustrated embodiment, the interactive environment 10 includes a display 12 configured to present images to a user. In addition, the interactive environment 10 includes a user-manipulated object 14 configured to be manipulated by the user within the interactive environment 10. For example, the user-manipulated object 14 may include a pointer, a simulated armament (e.g., sword, ray gun, etc.), etc. Furthermore, the interactive environment includes multiple sensors 16 configured to output sensor signals indicative of an orientation of the user-manipulated object 14 (e.g., a quaternion of the user-manipulated object 14). As discussed in detail below, the sensors 16 are part of a tracking system configured to track the user-manipulated object 14 within the interactive environment 10. In the illustrated embodiment, the tracking system includes three sensors 16. However, in other embodiments, the tracking system may include more or fewer sensors (e.g., 1, 2, 4, 5, 6, 7, 8, or more).

Furthermore, the tracking system includes a controller communicatively coupled to the sensor(s) 16 and to the display 12. The controller is configured to adjust an image 18 on the display 12 based on the orientation of the user-manipulated object 14. For example, as the user changes the orientation of the user-manipulated object 14, the controller may control the display 12 to move a virtual object 20 on the display 12 (e.g., upward, downward, left, right, etc.).

In certain embodiments, the controller of the tracking system is configured to receive a sensor signal from the sensor(s) 16 indicative of a latest quaternion of the user-manipulated object 14. The controller is also configured to update a quaternion array with the latest quaternion. The quaternion array includes multiple quaternions, the quaternions are arranged in chronological order within the quaternion array, and updating the quaternion array with the latest quaternion includes adding the latest quaternion to the quaternion array and removing an oldest quaternion from the quaternion array. Furthermore, the controller is configured to determine a reference axis and a reference angle of the latest quaternion (e.g., via converting the quaternion into an angle-axis). The controller is also configured to determine a relative angle and a relative time for each quaternion within the quaternion array except for the latest quaternion. The relative angle is about the reference axis, the relative angle is determined via an axis projection process, and the relative time is a difference between a time of the quaternion and a time of the latest quaternion. In addition, the controller is configured to determine an angular velocity and an angular acceleration about the reference axis by applying a filter to a set of kinematic equations. The relative angle and the relative time for each quaternion within the quaternion array, except for the latest quaternion, are inputs for each respective kinematic equation of the set of kinematic equations. The controller is also configured to determine a future angle of the user-manipulated object 14 based on the angular velocity and the angular acceleration about the reference axis. Furthermore, the controller is configured to determine a future quaternion from the future angle and the reference axis, and the controller is configured to output an output signal indicative of the future quaternion. For example, the output signal indicative of the future quaternion may include instructions to adjust the image 18 on the display 12 based on the future quaternion. Because the controller may control the display based on the determined future quaternion, the image on the display may be updated based on a predicted current orientation of the user-manipulated object (e.g., corresponding to the future quaternion), thereby substantially reducing or eliminating latency (e.g., as compared to a tracking system that attempts to determine a current orientation of the user-manipulated object based on direct feedback from the sensor(s)). The reduction or elimination of latency (e.g., between rotation of the user-manipulated object and adjustment to the image on the display) may enhance user satisfaction with the interactive environment.

FIG. 2 is a block diagram of an embodiment of a tracking system 22 for a user-manipulated object that may be employed within the interactive environment of FIG. 1. As previously discussed, the tracking system 22 includes the sensor(s) 16. The sensor(s) 16 may include any suitable type(s) of sensor(s) configured to monitor the orientation of the user-manipulated object. For example, the sensor(s) 16 may include sensor(s) coupled to the user-manipulated object, such as gyroscopic sensor(s), accelerometer(s), inertial measurement unit(s), other suitable type(s) of sensor(s), or a combination thereof. Additionally or alternatively, the sensor(s) 16 may include sensor(s) positioned remote from the user-manipulated object, such as LiDAR sensor(s), radar sensor(s), ultrasonic sensor(s), infrared sensor(s), camera(s), other suitable type(s) of sensor(s), or a combination thereof.

In the illustrated embodiment, the tracking system 22 includes a controller 24 communicatively coupled to the sensor(s) 16. In certain embodiments, the controller 24 is an electronic controller having electrical circuitry configured to receive sensor signal(s) from the sensor(s) 16. In the illustrated embodiment, the controller 24 includes a processor 26, such as a microprocessor. The controller 24 may also include one or more storage devices such as the illustrated memory device 28 and/or other suitable components. The processor 26 may be used to execute software, such as software for controlling the display 12, and so forth. Moreover, the processor 26 may include multiple microprocessors, one or more “general-purpose” microprocessors, one or more special-purpose microprocessors, one or more application specific integrated circuits (ASICs), one or more reduced instruction set (RISC) processors, or some combination thereof.

The memory device 28 may include a volatile memory such as random access memory (RAM), and/or a nonvolatile memory such as read-only memory (ROM). The memory device 28 may store a variety of information and may be used for various purposes. For example, the memory device 28 may store processor-executable instructions (e.g., firmware or software) for the processor 26 to execute, such as instructions for controlling the display 12, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the display 12, etc.), and any other suitable data.

As illustrated, the display 12 is communicatively coupled to the controller 24. As previously discussed, the display 12 is configured to present images to the user. The display may include any suitable type(s) of display device(s), such as projector(s), LCD screen(s), LED screen(s), other suitable type(s) of display device(s), or a combination thereof. The display may be flat, curved, angled, or the display may have another suitable shape. For example, in certain embodiments, the display may at least partially surround the user.

As discussed in detail below, the controller 24 is configured to receive a sensor signal from the sensor(s) 16 indicative of a latest quaternion of the user-manipulated object. The controller 24 is also configured to update a quaternion array with the latest quaternion. The quaternion array includes multiple quaternions, the quaternions are arranged in chronological order within the quaternion array, and updating the quaternion array with the latest quaternion includes adding the latest quaternion to the quaternion array and removing an oldest quaternion from the quaternion array. Furthermore, the controller 24 is configured to determine a reference axis and a reference angle of the latest quaternion, and the controller 24 is configured to determine a relative angle and a relative time for each quaternion within the quaternion array except for the latest quaternion. The relative angle is about the reference axis, the relative angle is determined via an axis projection process, and the relative time is a difference between a time of the quaternion and a time of the latest quaternion. In addition, the controller 24 is configured to determine an angular velocity and an angular acceleration about the reference axis by applying a filter to a set of kinematic equations. The relative angle and the relative time for each quaternion within the quaternion array, except for the latest quaternion, are inputs for each respective kinematic equation of the set of kinematic equations. The controller 24 is also configured to determine a future angle of the user-manipulated object based on the angular velocity and the angular acceleration about the reference axis, and the controller 24 is configured to determine a future quaternion from the future angle and the reference axis. In addition, the controller 24 is configured to output an output signal indicative of the future quaternion.

In certain embodiments, the output signal indicative of the future quaternion includes instructions to adjust an image on the display 12 based on the future quaternion. For example, as the user changes the orientation of the user-manipulated object, the controller 24 may control the display 12 to move a virtual object on the display 12 (e.g., upward, downward, left, right, etc.). Additionally or alternatively, the controller 24 may change the state of the virtual object on the display 12 based on the orientation of the user-manipulated object (e.g., the controller 24 may scroll through different representations of the virtual object on the display 12, the controller 24 may change the virtual object from an intact state to a deformed state, etc.). Because the controller may control the display based on the determined future quaternion, the image on the display may be updated based on a predicted current orientation of the user-manipulated object (e.g., corresponding to the future quaternion), thereby substantially reducing or eliminating latency (e.g., as compared to a tracking system that attempts to determine a current orientation of the user-manipulated object based on direct feedback from the sensor(s)). The reduction or elimination of latency (e.g., between rotation of the user-manipulated object and adjustment to the image on the display) may enhance user satisfaction with the interactive environment. While an output signal having instructions to adjust the image on the display is disclosed above, in certain embodiments, the output signal may include other suitable instructions, such as instructions to control a physical object, etc.

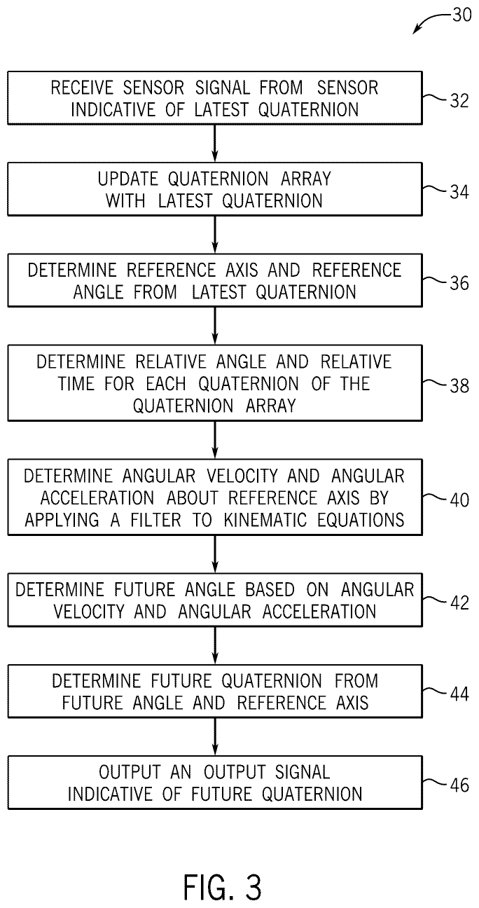

FIG. 3 is a flow diagram of an embodiment of a method 30 for tracking a user-manipulated object within an interactive environment. The method 30 may be performed by the controller disclosed above with reference to FIG. 2, by one or more other suitable controllers, or a combination thereof. Furthermore, the steps of the method 30 may be performed in the order disclosed below or in any other suitable order. In addition, in certain embodiments, one or more steps of the method 30 may be omitted, and/or the method may include one or more additional steps.

The method 30 includes receiving a sensor signal indicative of a latest quaternion of the user-manipulated object, as represented by block 32. For example, the sensor(s) of the tracking system disclosed above with reference to FIG. 2 may periodically output sensor signal(s) indicative of a quaternion of the user-manipulated object. For example, the sensor(s) may output the sensor signal(s) at a rate of 0.5 Hz, 1 Hz, 2 Hz, etc. The latest quaternion corresponds to the most recent quaternion of the user-manipulated object. In certain embodiments, each quaternion of the user-manipulated object is determined (e.g., by the controller) based on the signal(s) from the sensor(s).

Furthermore, the method 30 includes updating a quaternion array with the latest quaternion, as represented by block 34. The quaternion array includes multiple quaternions, in which each quaternion is a quaternion of the user-manipulated object at a particular time. The quaternions are arranged in chronological order within the quaternion array. In certain embodiments, the quaternions within the quaternion array include directly successive quaternions (e.g., based on directly successive sensor measurements). For example, if the sensor(s) are configured to output the sensor signal(s) at a rate of 1 Hz, the quaternions within the quaternion array may be separated by one second intervals. However, in other embodiments, the quaternions within the quaternion array may include non-successive quaternions (e.g., every other quaternion, every third quaternion, quaternions separated by unequal time intervals, etc.). Furthermore, the quaternion array has a suitable number of elements (e.g., quaternions), such as 3, 4, 5, 6, 7, 8, or more. For example, in certain embodiments, the quaternion array has four quaternions arranged in chronological order, with the latest quaternion being the last quaternion within the quaternion array. In certain embodiments, the number of quaternions within the quaternion array is fixed. However, in other embodiments, the number of quaternions within the quaternion array may vary during operation of the tracking system. Updating the quaternion array with the latest quaternion includes adding the latest quaternion to the quaternion array and removing the oldest quaternion from the quaternion array. Accordingly, the quaternion array is a moving window of quaternions. In certain embodiments, the quaternion array has the most recent quaternions of the user-manipulated object (e.g., the four most recent quaternions of the user-manipulated object).

The method 30 also includes determining a reference axis and a reference angle of the latest quaternion, as represented by block 36. Determining the reference axis and the reference angle includes converting the latest quaternion to an angle-axis (e.g., the angle-axis form of the latest quaternion). The angle-axis includes an axis and an angle. Accordingly, the axis of the angle-axis of the latest quaternion corresponds to the reference axis, and the angle of the angle-axis of the latest quaternion corresponds to the reference angle.

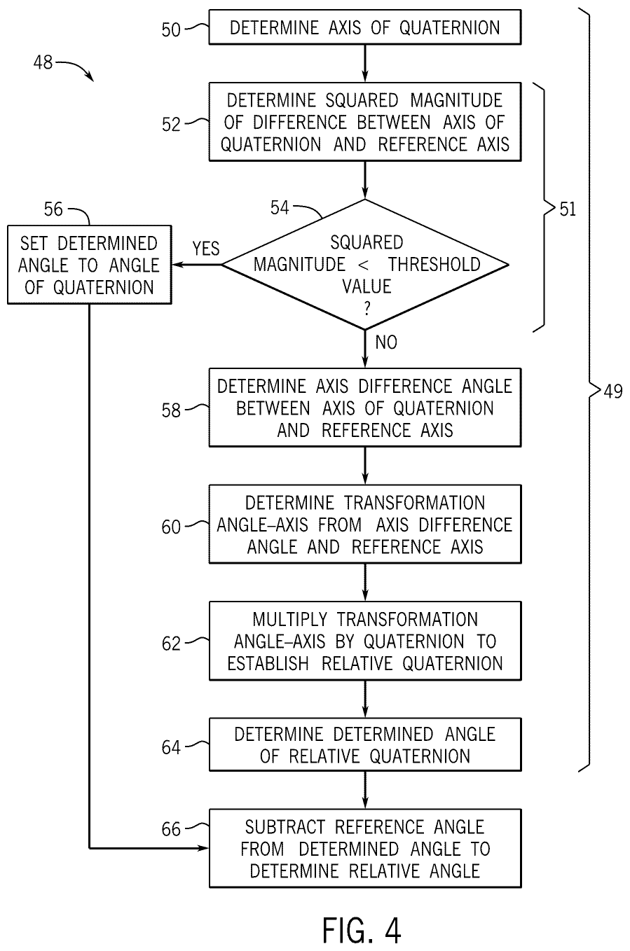

Furthermore, the method 30 includes determining a relative angle and a relative time for each quaternion within the quaternion array except for the latest quaternion, as represented by block 38. For example, if the quaternion array includes four quaternions, the relative angle and the relative time are determined for three quaternions. The relative angle is about the reference axis, and the relative angle is determined via an axis projection process, as discussed in detail below with reference to FIG. 4. Furthermore, the relative time is the difference between a time of the quaternion and a time of the latest quaternion (e.g., the time of the latest quaternion minus the time of the quaternion).

In addition, the method 30 includes determining an angular velocity and an angular acceleration about the reference axis by applying a filter to a set of kinematic equations, as represented by block 40. The relative angle and the relative time for each quaternion within the quaternion array, except for the latest quaternion, are inputs for each respective kinematic equation of the set of kinematic equations. Each kinematic equation of the set of kinematic equations may be represented as:

$$θ = ω t + \frac{1}{2} α {t}^{2} \qquad ( 1 )$$

where θ is the relative angle for the quaternion, t is the relative time for the quaternion, ω is the angular velocity, and α is the angular acceleration. The number of kinematic equations within the set is equal to one less than the number of elements within the quaternion array. For example, if the quaternion array includes four quaternions, the set of kinematic equations includes three equations. Because the number of equations (e.g., three) is greater than the number of unknowns (e.g., the angular velocity and the angular acceleration), the filter is used to solve for the unknowns. In certain embodiments, the filter is a least squares fit. However, in other embodiments, another suitable type of filter may be used (e.g., Kalman filter, etc.).

The method also includes determining a future angle of the user-manipulated object based on the angular velocity and the angular acceleration about the reference axis, as represented by block 42. The future angle at any future time may be determined using equation (1), the angular velocity and the angular acceleration, as determined in block 40, and the future time. The future time is the time since the time of the latest quaternion, and the future angle is the rotation about the reference axis from the reference angle. For example, the future time may correspond to the current time (e.g., time since the time of the latest quaternion). Accordingly, the future angle may correspond to a predicted current angle of the user-manipulated object (e.g., angle about the reference axis from the reference angle).

Furthermore, the method 30 includes determining a future quaternion from the future angle and the reference axis, as represented by block 44. Determining the future quaternion includes establishing a future angle-axis that includes the reference axis as the axis of the future angle-axis, and the future angle as the angle of the future angle-axis. In addition, determining the future quaternion includes converting the future angle-axis to quaternion form, thereby establishing the future quaternion.

In addition, the method 30 includes outputting an output signal indicative of the future quaternion, as represented by block 46. For example, as previously discussed, the future time may be selected to correspond to the current time (e.g., time since the time of the latest quaternion). Accordingly, the future quaternion may correspond to the predicted quaternion of the user-manipulated object at the current time. Furthermore, the output signal indicative of the future quaternion may include instructions to adjust the image on the display based on the future quaternion. Because the display is controlled based on the determined future quaternion, and the future quaternion may correspond to the predicted quaternion at the current time, the image on the display may be updated based on a predicted instantaneous or near-instantaneous orientation of the user-manipulated object, thereby substantially reducing or eliminating latency (e.g., as compared to a tracking system that attempts to determine a current orientation of the user-manipulated object based on direct feedback from the sensor(s)). The reduction or elimination of latency (e.g., between rotation of the user-manipulated object and adjustment to the image on the display) may enhance user satisfaction with the interactive environment. While an output signal having instructions to adjust the image on the display is disclosed above, in certain embodiments, the output signal may include other suitable instructions, such as instructions to control a physical object, etc. Furthermore, while selecting a future time that corresponds to the current time is disclosed above, any suitable future time may be selected (e.g., before or after the current time).

While each kinematic equation of the set of kinematic equations (e.g., equation (1) above) includes the angular velocity and the angular acceleration in the embodiments disclosed herein, in certain embodiments, each kinematic equation of the set of kinematic equations may include one or more higher order terms (e.g., the third derivative of position, the fourth derivative of position, etc.). In such embodiments, the higher order terms may be determined in block 40 and used to determine the future angle in block 42.

FIG. 4 is a flow diagram of an embodiment of a relative angle determination process 48, including an axis projection process 49, which may be employed within the method of FIG. 3. The relative angle determination process 48 may be performed by the controller disclosed above with reference to FIG. 2, by one or more other suitable controllers, or a combination thereof. Furthermore, the steps of the relative angle determination process 48 may be performed in the order disclosed below or in any other suitable order. In addition, in certain embodiments, one or more steps of the relative angle determination process 48 may be omitted, and/or the relative angle determination process may include one or more additional steps.

In certain embodiments, the process of determining the relative angle for each quaternion within the quaternion array, except for the latest quaternion, as represented by block 38 in FIG. 3, includes iteratively performing the relative angle determining process 48 for each quaternion within the quaternion array except for the latest quaternion. The relative angle determination process 48 includes the axis projection process 49, and the axis projection process 49 includes determining an axis of the quaternion, as represented by block 50. Determining the axis of the quaternion includes converting the quaternion to an angle-axis (e.g., the angle-axis form of the quaternion). The angle-axis includes an axis and an angle. Accordingly, the axis of the angle-axis corresponds to the axis of the quaternion.

In certain embodiments, the axis projection process 49 includes performing a comparison process 51. The comparison process includes determining a squared magnitude of a difference between the axis of the quaternion and the reference axis, as represented by block 52. The difference between the axis of the quaternion and the reference axis may be determined using vector subtraction (e.g., subtracting the axis of the quaternion from the reference axis) to obtain a difference vector. In addition, the squared magnitude may be determined by adding the squares of the components of the difference vector to one another.

The squared magnitude of the difference between the axis of the quaternion and the reference axis is compared to a threshold value, as represented by block 54. In response to determining the squared magnitude of the difference between the axis of the quaternion and the reference axis is less than the threshold value, a determined angle is set to the angle of the quaternion, as presented by block 56. Otherwise, the axis projection process continues to block 58. Determining the angle of the quaternion includes converting the quaternion to an angle-axis (e.g., the angle-axis form of the quaternion), which may have been previously completed at block 50. As previously discussed, the angle-axis includes an axis and an angle. Accordingly, the angle of the angle-axis corresponds to the angle of the quaternion. Furthermore, the threshold value may be any suitable value, such as between 0.000001 and 0.001. For example, in certain embodiments, the threshold value may be 0.00001.

In response to determining the squared magnitude of the difference between the axis of the quaternion and the reference axis is not less than the threshold value (e.g., greater than or equal to the threshold value), an axis difference angle between the axis of the quaternion and the reference axis is determined, as represented by block 58. Accordingly, the comparison process 51 is performed before determining the axis difference angle. In certain embodiments, the axis difference angle is determined using the equation:

$$δ = {cos}^{- 1} \frac{axis \cdot ref\_axis}{‖ axis ‖ ‖ ref\_axis ‖} \qquad ( 2 )$$

where “axis” is the axis of the quaternion, ref_axis is the reference axis, and δ is the axis difference angle. Furthermore, ∥ axis ∥ represents the magnitude of the axis of the quaternion, and ∥ref_axis ∥ represents the magnitude of the reference axis. The magnitude of each axis may be determined by adding the squares of the components of the axis to one another and taking the square root of the resultant value. While the axis difference angle is determined by equation (2) in certain embodiments, in other embodiments the axis difference angle may be determined by another suitable technique.

Furthermore, the axis projection process 49 includes determining a transformation angle-axis from the axis difference angle and the reference axis, as represented by block 60. As previously discussed, an angle-axis includes an angle and an axis. In certain embodiments, the angle of the transformation angle-axis is set to the negative axis difference angle, and the axis is set to the reference axis, thereby forming the transformation angle-axis.

The axis projection process 49 also includes multiplying the transformation angle-axis by the quaternion to establish a relative quaternion, as represented by block 62. Quaternion multiplication represents a rotation through both quaternions of the multiplication. In certain embodiments, the transformation angle-axis may be multiplied directly by the quaternion. In other embodiments, the transformation angle-axis may be converted to a transformation quaternion before the transformation quaternion is multiplied by the quaternion.

In addition, the axis projection process 49 includes determining the determined angle of the relative quaternion, as represented by block 64. Determining the determined angle includes converting the relative quaternion to an angle-axis (e.g., the angle-axis form of the relative quaternion). As previously discussed, the angle-axis includes an axis and an angle. Accordingly, the angle of the angle-axis of the relative quaternion corresponds to the determined angle. If the squared magnitude of the difference between the axis of the quaternion and the reference axis is less than the threshold value, the determined angle is set to the angle of the quaternion. However, if the squared magnitude of the difference between the axis of the quaternion and the reference axis is not less than the threshold value (e.g., greater than or equal to the threshold value), the determined angle is determined by the process represented by blocks 58-64. While the axis projection process 49 includes the comparison process 51 in the illustrated embodiment, in other embodiments, the comparison process may be omitted (e.g., the determined angle may be determined by the process represented by blocks 58-64).

Furthermore, the relative angle determination process 48 includes subtracting the reference angle from the determined angle (e.g., as set in block 56 or as determined in block 64) to determine the relative angle, as represented by block 66. As previously discussed, the relative angle is an input to the kinematic equation for the quaternion, as discussed above with reference to block 40.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A tracking system for a user-manipulated object within an interactive environment, the tracking system comprising:
a controller comprising a memory and a processor, wherein the controller is configured to:
receive a sensor signal, from a sensor, indicative of a latest quaternion of the user-manipulated object;
update a quaternion array with the latest quaternion, wherein the quaternion array comprises a plurality of quaternions, the plurality of quaternions are arranged in chronological order within the quaternion array, and updating the quaternion array with the latest quaternion comprises adding the latest quaternion to the quaternion array and removing an oldest quaternion from the quaternion array;
determine a reference axis and a reference angle of the latest quaternion;
determine a relative angle and a relative time for each quaternion of the plurality of quaternions within the quaternion array except for the latest quaternion, wherein the relative angle is about the reference axis, the relative angle is determined via an axis projection process, and the relative time is a difference between a time of the quaternion and a time of the latest quaternion;
determine an angular velocity and an angular acceleration about the reference axis by applying a filter to a plurality of kinematic equations, wherein the relative angle and the relative time for each quaternion of the plurality of quaternions within the quaternion array, except for the latest quaternion, are inputs for each respective kinematic equation of the plurality of kinematic equations;
determine a future angle of the user-manipulated object based on the angular velocity and the angular acceleration about the reference axis;
determine a future quaternion from the future angle and the reference axis; and
output an output signal indicative of the future quaternion.

2. The tracking system of claim 1, comprising the sensor configured to output the sensor signal indicative of the latest quaternion of the user-manipulated object.

3. The tracking system of claim 1, wherein determining the relative angle for each quaternion of the plurality of quaternions within the quaternion array, except for the latest quaternion, comprises iteratively performing a relative angle determination process, wherein the relative angle determination process comprises:
performing the axis projection process, wherein the axis projection process comprises:
determining an axis of the quaternion;
determining an axis difference angle between the axis of the quaternion and the reference axis;
determining a transformation angle-axis from the axis difference angle and the reference axis;
multiplying the transformation angle-axis by the quaternion to establish a relative quaternion; and
determining a determined angle of the relative quaternion; and
subtracting the reference angle from the determined angle to determine the relative angle.

4. The tracking system of claim 3, wherein the axis difference angle is determined using the equation:
$$δ = {cos}^{- 1} \frac{axis \cdot ref\_axis}{‖ axis ‖ ‖ ref\_axis ‖}$$
where axis is the axis of the quaternion, ref_axis is the reference axis, and δ is the axis difference angle.

5. The tracking system of claim 3, wherein the axis projection process comprises performing a comparison process before determining the axis difference angle, wherein the comparison process comprises:
determining a squared magnitude of a difference between the axis of the quaternion and the reference axis; and
setting the determined angle to an angle of the quaternion in response to determining the squared magnitude is less than a threshold value.

6. The tracking system of claim 1, wherein the filter comprises a least squares fit.

7. The tracking system of claim 1, wherein the output signal indicative of the future quaternion comprises instructions to adjust an image on a display within the interactive environment based on the future quaternion.

8. A method for tracking a user-manipulated object within an interactive environment, the method comprising:
receiving, via a controller comprising a memory and a processor, a sensor signal from a sensor indicative of a latest quaternion of the user-manipulated object;
updating, via the controller, a quaternion array with the latest quaternion, wherein the quaternion array comprises a plurality of quaternions, the plurality of quaternions are arranged in chronological order within the quaternion array, and updating the quaternion array with the latest quaternion comprises adding the latest quaternion to the quaternion array and removing an oldest quaternion from the quaternion array;
determining, via the controller, a reference axis and a reference angle of the latest quaternion;
determining, via the controller, a relative angle and a relative time for each quaternion of the plurality of quaternions within the quaternion array except for the latest quaternion, wherein the relative angle is about the reference axis, the relative angle is determined via an axis projection process, and the relative time is a difference between a time of the quaternion and a time of the latest quaternion;
determining, via the controller, an angular velocity and an angular acceleration about the reference axis by applying a filter to a plurality of kinematic equations, wherein the relative angle and the relative time for each quaternion of the plurality of quaternions within the quaternion array, except for the latest quaternion, are inputs for each respective kinematic equation of the plurality of kinematic equations;
determining, via the controller, a future angle of the user-manipulated object based on the angular velocity and the angular acceleration about the reference axis;
determining, via the controller, a future quaternion from the future angle and the reference axis; and
outputting, via the controller, an output signal indicative of the future quaternion.

9. The method of claim 8, wherein each kinematic equation of the plurality of kinematic equations comprises:
$$θ = ω t + \frac{1}{2} α {t}^{2}$$
where θ is the relative angle for the quaternion, t is the relative time for the quaternion, @ is the angular velocity, and α is the angular acceleration.

10. The method of claim 8, wherein determining the relative angle for each quaternion of the plurality of quaternions within the quaternion array, except for the latest quaternion, comprises iteratively performing, via the controller, a relative angle determination process, wherein the relative angle determination process comprises:
performing the axis projection process, wherein the axis projection process comprises:
determining an axis of the quaternion;
determining an axis difference angle between the axis of the quaternion and the reference axis;
determining a transformation angle-axis from the axis difference angle and the reference axis;
multiplying the transformation angle-axis by the quaternion to establish a relative quaternion; and
determining a determined angle of the relative quaternion; and
subtracting the reference angle from the determined angle to determine the relative angle.

11. The method of claim 10, wherein the axis difference angle is determined using the equation:
$$δ = {cos}^{- 1} \frac{axis \cdot ref\_axis}{‖ axis ‖ ‖ ref\_axis ‖}$$
where axis is the axis of the quaternion, ref_axis is the reference axis, and δ is the axis difference angle.

12. The method of claim 10, wherein the axis projection process comprises performing a comparison process before determining the axis difference angle, wherein the comparison process comprises:
determining a squared magnitude of a difference between the axis of the quaternion and the reference axis; and
setting the determined angle to an angle of the quaternion in response to determining the squared magnitude is less than a threshold value.

13. The method of claim 8, wherein the filter comprises a least squares fit.

14. The method of claim 8, wherein the output signal indicative of the future quaternion comprises instructions to adjust an image on a display within the interactive environment based on the future quaternion.

15. An interactive environment, comprising:
a user-manipulated object;
a display; and
a tracking system comprising:
a sensor configured to output a sensor signal indicative of a latest quaternion of the user-manipulated object; and
a controller comprising a memory and a processor, wherein the controller is communicatively coupled to the sensor, and the controller is configured to:
receive the sensor signal, from the sensor, indicative of the latest quaternion of the user-manipulated object;
update a quaternion array with the latest quaternion, wherein the quaternion array comprises a plurality of quaternions, the plurality of quaternions are arranged in chronological order within the quaternion array, and updating the quaternion array with the latest quaternion comprises adding the latest quaternion to the quaternion array and removing an oldest quaternion from the quaternion array;
determine a reference axis and a reference angle of the latest quaternion;
determine a relative angle and a relative time for each quaternion of the plurality of quaternions within the quaternion array except for the latest quaternion, wherein the relative angle is about the reference axis, the relative angle is determined via an axis projection process, and the relative time is a difference between a time of the quaternion and a time of the latest quaternion;
determine an angular velocity and an angular acceleration about the reference axis by applying a filter to a plurality of kinematic equations, wherein the relative angle and the relative time for each quaternion of the plurality of quaternions within the quaternion array, except for the latest quaternion, are inputs for each respective kinematic equation of the plurality of kinematic equations;
determine a future angle of the user-manipulated object based on the angular velocity and the angular acceleration about the reference axis;
determine a future quaternion from the future angle and the reference axis; and
output an output signal indicative of instructions to adjust an image on the display based on the future quaternion.

16. The interactive environment of claim 15, wherein determining the relative angle for each quaternion of the plurality of quaternions within the quaternion array, except for the latest quaternion, comprises iteratively performing a relative angle determination process, wherein the relative angle determination process comprises:
performing the axis projection process, wherein the axis projection process comprises:
determining an axis of the quaternion;
determining an axis difference angle between the axis of the quaternion and the reference axis;
determining a transformation angle-axis from the axis difference angle and the reference axis;
multiplying the transformation angle-axis by the quaternion to establish a relative quaternion; and
determining a determined angle of the relative quaternion; and
subtracting the reference angle from the determined angle to determine the relative angle.

17. The interactive environment of claim 16, wherein the axis difference angle is determined using the equation:
$$δ = {cos}^{- 1} \frac{axis \cdot ref\_axis}{‖ axis ‖ ‖ ref\_axis ‖}$$
where axis is the axis of the quaternion, ref_axis is the reference axis, and δ is the axis difference angle.

18. The interactive environment of claim 16, wherein the axis projection process comprises performing a comparison process before determining the axis difference angle, wherein the comparison process comprises:
determining a squared magnitude of a difference between the axis of the quaternion and the reference axis; and
setting the determined angle to an angle of the quaternion in response to determining the squared magnitude is less than a threshold value.

19. The interactive environment of claim 15, wherein the filter comprises a least squares fit.

20. The interactive environment of claim 15, wherein each kinematic equation of the plurality of kinematic equations comprises:
$$θ = ω t + \frac{1}{2} α {t}^{2}$$
where θ is the relative angle for the quaternion, t is the relative time for the quaternion, ω is the angular velocity, and α is the angular acceleration.
